(19) United States
(12) Patent Application Publication
(10) Pub. No.: US 2022/0284338 A1
(43) Pub. Date: Sep. 8, 2022

(54) Heterogeneous Agent Formation Control Method Based on Cloud-Model-Based Quantum Genetic Algorithm

(71) Applicant: Institute of Oceanographic Instrumentation, Shandong Academy of Sciences, Qingdao (CN)

(72) Inventors: Junhe Wan, Qingdao (CN); Yi Zheng, Qingdao (CN); Hailin Liu, Qingdao (CN)

(21) Appl. No.: 17/300,933

(22) Filed: Dec. 15, 2021

(30) Foreign Application Priority Data
Dec. 15, 2020 (CN) 202011477297.2

(51) Int. Cl. G06N 10/60; B63G 8/00; B63G 8/14; G06N 10/20; G06N 10/40

(52) U.S. Cl. CPC G06N 10/60; B63G 8/001; B63G 8/14; G06N 10/20; G06N 10/40; B63G 2008/004

(57) ABSTRACT

The disclosure provides a heterogeneous agent formation control method based on a cloud-model-based quantum genetic algorithm. Heterogeneous agents include a surface unmanned vehicle and an autonomous underwater vehicle. The control method includes the following steps: establishing a dynamics model of a surface unmanned vehicle and an autonomous underwater vehicle; designing formation behaviors of the heterogeneous agents based on a behavior algorithm and a leader-follower algorithm by using the established dynamics model; and optimizing weight coefficients of different behaviors of the heterogeneous agents based on a cloud-model-based quantum genetic algorithm by using the established dynamics model to obtain an optimal formation control strategy and implement formation control over the heterogeneous agents. The method disclosed by the present invention can implement integrated formation control over the surface unmanned vehicle and the autonomous underwater vehicle to improve operating efficiency and expand an operating range.

### TECHNICAL FIELD

The present invention relates to the field of heterogeneous agent formation control, and in particular, to a heterogeneous agent formation control method based on a cloud-model-based quantum genetic algorithm.

### BACKGROUND

Facing the complicated and volatile marine environments, integrated water surface-to-underwater observation has become a hot spot and an important development trend in international frontier research. Therefore, unmanned surface vehicles (USVs) and autonomous underwater vehicles (AUVs) have received more and more attention and research in the fields such as anti-submarine, anti-torpedo, intelligence, surveillance and reconnaissance, underwater topography and geomorphology mapping, tracking and investigation of specific targets, and acquisition of marine environment data. However, a single agent executing these tasks often has disadvantages such as a low carrying capacity, small coverage, and a weak information processing capacity.

At present, most research focuses on formation control over USVs or AUVs alone but does not organically combine the USVs and the AUVs, while most of actual tasks require water surface-to-underwater coordination. Apparently, agents of a single structure are limited in their application and have low task execution efficiency. How to organically combine the functions of the USVs and the AUVs so that agents in a formation share information and obtain information required by themselves to achieve higher operating efficiency and wider coverage is a key problem currently urgent to be solved.

### SUMMARY

To solve the foregoing technical problems, the present invention provides a heterogeneous agent formation control method based on a cloud-model-based quantum genetic algorithm, so as to implement integrated formation control over a surface unmanned vehicle and an autonomous underwater vehicle to improve operating efficiency and expand an operating range.

To achieve the foregoing objectives, the present invention provides the following technical solutions:

Disclosed is a heterogeneous agent formation control method based on a cloud-model-based quantum genetic algorithm. Heterogeneous agents include a surface unmanned vehicle and an autonomous underwater vehicle. The control method includes the following steps:

step 1: establishing a dynamics model of a surface unmanned vehicle and an autonomous underwater vehicle;

step 2: designing formation behaviors of the heterogeneous agents based on a behavior algorithm and a leader-follower algorithm by using the established dynamics model of a surface unmanned vehicle and an autonomous underwater vehicle; and

step 3: optimizing weight coefficients of different behaviors of the heterogeneous agents based on a cloud-model-based quantum genetic algorithm by using the established dynamics model of a surface unmanned vehicle and an autonomous underwater vehicle to obtain an optimal formation control strategy and implement formation control over the heterogeneous agents.

In the forgoing solution, in step 1, a three-degrees of freedom dynamics model is established without considering a motion in a z direction for the surface unmanned vehicle, as shown in Equation (1):

$$\{ \begin{matrix}{\dot{ξ}}^{U} = {u}^{U} cos {ψ}^{U} - {v}^{U} sin {ψ}^{U} \\ {\dot{η}}^{U} = {u}^{U} sin {ψ}^{U} + {v}^{U} cos {ψ}^{U} \\ {\dot{ψ}}^{U} = {r}^{U}\end{matrix} \qquad ( 1 )$$

\dot{ξ}^{U} denotes a derivative of displacement of the surface unmanned vehicle along an x axis; u^{U} denotes a linear velocity of the surface unmanned vehicle along the x axis; ψ^{U} denotes a heading angle of the surface unmanned vehicle; v^{U} denotes a linear velocity of the surface unmanned vehicle along a y axis; \dot{η}^{U} denotes a derivative of displacement of the surface unmanned vehicle along the y axis; \dot{ψ}^{U} denotes a derivative of the heading angle of the surface unmanned vehicle; and r^{U} denotes a yaw angular velocity of the surface unmanned vehicle; and

a six-degrees of freedom dynamics model is established for the autonomous underwater vehicle, as shown in Equation (2):

$$\{ \begin{matrix}{\dot{ξ}}^{A} = \begin{matrix}{u}^{A} cos {θ}^{A} cos {ψ}^{A} + {v}^{A} ( sin {φ}^{A} sin {θ}^{A} cos {ψ}^{A} - cos {ψ}^{A} sin {ψ}^{A} ) + \\ {w}^{A} ( sin {φ}^{A} sin {ψ}^{A} - cos {φ}^{A} sin {θ}^{A} cos {ψ}^{A} )\end{matrix} \\ {\dot{η}}^{A} = \begin{matrix}{u}^{A} cos {θ}^{A} sin {ψ}^{A} + {v}^{A} ( cos {φ}^{A} cos {ψ}^{A} - sin {ϕ}^{A} sin {θ}^{A} sin {ψ}^{A} ) + \\ {w}^{A} ( cos {φ}^{A} sin {θ}^{A} sin {ψ}^{A} - sin {φ}^{A} cos {ψ}^{A} )\end{matrix} \\ {ζ}^{\dot{A}} = - {u}^{A} sin {θ}^{A} + {v}^{A} cos {θ}^{A} sin {φ}^{A} + {w}^{A} cos {θ}^{A} cos {φ}^{A} \\ {\dot{φ}}^{A} = {p}^{A} + {\dot{ψ}}^{A} sin {θ}^{A} \\ {\dot{θ}}^{A} = {q}^{A} cos {φ}^{A} - {r}^{A} sin {φ}^{A} \\ {\dot{ψ}}^{A} = \frac{{r}^{A} cos {φ}^{A} - {q}^{A} sin {φ}^{A}}{cos {θ}^{A}}\end{matrix} , \qquad ( 2 )$$

where

\dot{ξ}^{A} denotes a derivative of displacement of the autonomous underwater vehicle along the x axis; u^{A} denotes a linear velocity of the autonomous underwater vehicle along the x axis; θ^{A} denotes a pitch angle of the autonomous underwater vehicle; ψ^{A} denotes a heading angle of the autonomous underwater vehicle; v^{A} denotes a linear velocity of the autonomous underwater vehicle along the y axis; φ^{A} denotes a roll angle of the autonomous underwater vehicle; w^{A} denotes a linear velocity of the autonomous underwater vehicle along the z axis; \dot{η}^{A} denotes a derivative of displacement of the autonomous underwater vehicle along the y axis; \dot{ζ}^{A} denotes a derivative of displacement of the autonomous underwater vehicle along the z axis; \dot{φ}^{A} denotes a derivative of the roll angle of the autonomous underwater vehicle; p^{A} denotes a heeling angular velocity of the autonomous underwater vehicle; \dot{ψ}^{A} denotes a derivative of the heading angle of the autonomous underwater vehicle; \dot{θ}^{A} denotes a derivative of the pitch angle of the autonomous underwater vehicle; q^{A} denotes a trim angular velocity of the autonomous underwater vehicle; and r^{A} denotes a yaw angular velocity of the autonomous underwater vehicle.

In the forgoing solution, in step 2, the behaviors of the heterogeneous agents are classified into a move-to-goal behavior, a keep-formation behavior, an avoid-static-obstacle behavior, and an avoid-dynamic-obstacle behavior; and the heterogeneous agents include a leader and a follower, behaviors of the leader include the move-to-goal behavior, the avoid-static-obstacle behavior, and the avoid-dynamic-obstacle behavior, and behaviors of the follower include the keep-formation behavior, the avoid-static-obstacle behavior, and the avoid-dynamic-obstacle behavior.

In a further technical solution, the move-to-goal behavior is as follows: a current location and a goal location of the surface unmanned vehicle are respectively (x_{c}^{U}, y_{c}^{U}) and (x_{g}^{U}, y_{c}^{U}), and an output vector of the move-to-goal behavior of the surface unmanned vehicle is shown in Equation (3):

$${V}_{m t g}^{U} = \frac{1}{\sqrt{{( {x}_{g}^{U} - {x}_{c}^{U} )}^{2} + {( {y}_{g}^{U} - {y}_{c}^{U} )}^{2}}} ( \begin{matrix}{x}_{g}^{U} - {x}_{c}^{U} \\ {y}_{g}^{U} - {y}_{c}^{U}\end{matrix} ) ; \qquad ( 3 )$$

and

a current location and a goal location of the autonomous underwater vehicle are respectively (x_{c}^{A}, y_{c}^{A}, z_{c}^{A}) and (x_{g}^{A}, x_{g}^{A}, z_{g}^{A}), and an output vector of the move-to-goal behavior of the autonomous underwater vehicle is shown in Equation (4):

$${V}_{m t g}^{A} = \frac{1}{\sqrt{{( {x}_{g}^{A} - {x}_{c}^{A} )}^{2} + {( {y}_{g}^{A} - {y}_{c}^{A} )}^{2} + {( {z}_{g}^{A} - {z}_{c}^{A} )}^{2}}} ( \begin{matrix}{x}_{g}^{A} - {x}_{c}^{A} \\ {y}_{g}^{A} - {y}_{c}^{A} \\ {z}_{g}^{A} - {z}_{c}^{A}\end{matrix} ) . \qquad ( 4 )$$

In a further technical solution, a goal location of the keep-formation behavior of the surface unmanned vehicle is (x_{fg}^{U}, y_{fg}^{U}), and an output vector of the keep-formation behavior of the surface unmanned vehicle is shown in Equation (5):

$${V}_{k f}^{U} = \frac{1}{\sqrt{{( {x}_{f g}^{U} - {x}_{c}^{U} )}^{2} + {( {y}_{f g}^{U} - {y}_{c}^{U} )}^{2}}} ( \begin{matrix}{x}_{f g}^{U} - {x}_{c}^{U} \\ {y}_{f g}^{II} - {y}_{c}^{II}\end{matrix} ) ; \qquad ( 5 )$$

and

a goal location of the keep-formation behavior of the autonomous underwater vehicle is (x_{fg}^{A}, y_{fg}^{A}, z_{fg}^{A}), and an output vector of the keep-formation behavior of the autonomous underwater vehicle is shown in Equation (6):

$${V}_{k f}^{A} = \frac{1}{\sqrt{{( {x}_{f g}^{A} - {x}_{c}^{A} )}^{2} + {( {y}_{fg}^{A} - {y}_{c}^{A} )}^{2} + {( {z}_{f g}^{A} - {z}_{c}^{A} )}^{2}}} ( \begin{matrix}{x}_{f g}^{A} - {x}_{c}^{A} \\ {y}_{f g}^{A} - {y}_{c}^{A} \\ {z}_{f g}^{A} - {z}_{c}^{A}\end{matrix} ) . \qquad ( 6 )$$

In a further technical solution, the avoid-static-obstacle behavior is as follows: when detecting that an obstacle hinders its advancement, a heterogeneous agent makes a decision by using an obstacle avoidance function, and the obstacle avoidance function is defined as follows:

$${f}_{{OR}_{i}} = max \{ 0 , {N}_{O {R}_{i}} ( k ) \} ; where \qquad ( 7 )$$

$${N}_{O {R}_{i}} = \{ \begin{matrix}\begin{matrix}1 / d ( {p}_{{R}_{i}} ( k ) , {P}_{{OR}_{i}} ( k - 1 ) ) , \\ R < d ( {P}_{{R}_{i}} ( k ) , {P}_{O {R}_{i}} ( k - 1 ) ) < R + n\end{matrix} \\ 0 , d ( {P}_{{R}_{i}} ( k ) , {P}_{O {R}_{i}} ( k - 1 ) ) \geq R + D\end{matrix} ; \qquad ( 8 )$$

where

P_{R}_{ᵢ}(k) is an expected location in the k^{th} step; P_{OR}_{ᵢ}(k−1) is an edge location of an obstacle detected in the (k−1)^{th} step; D is a danger area range of the obstacle; R denotes an operating radius of the heterogeneous agent; d denotes a distance between the k^{th} step and the (k−1)th step; when f_{OR}_{ᵢ}=0, the obstacle does not need to be avoided; when f_{OR}_{ᵢ}≠0, the obstacle needs to be avoided; and in an obstacle avoidance process, no positive direction but only an xoy plane needs to be considered for the surface unmanned vehicle;

assuming that a current location of the heterogeneous agent is [x_{c}, y_{c}], and an included angle between a tangent line (between the heterogeneous agent and a boundary of the obstacle) and a current navigation direction is α, if

$$α < \frac{π}{4} ,$$

the heterogenous agent rotates by an angle of δ; or if

$$α \geq \frac{π}{4} ,$$

the agent rotates by angle of

$$\frac{π}{2} ;$$

and

the avoid-static-obstacle behavior of the heterogeneous agent is shown in Equation (9), where rotation to the left is positive and rotation to the right is negative:

$${V}_{a s o} = [ \begin{matrix}cos ( \pm δ ) & - sin ( \pm δ ) \\ sin ( \pm δ ) & cos ( \pm δ )\end{matrix} ] [ \begin{matrix}{x}_{c} \\ {y}_{c}\end{matrix} ] , \qquad ( 9 )$$

where

Vₐₛₒ denotes the avoid-static-obstacle behavior of the heterogeneous agent, and δ denotes a rotation angle of the heterogeneous agent.

In a further technical solution, the avoid-dynamic-obstacle behavior is as follows: assuming that a current location of a heterogeneous agent is [x_{c}, y_{c}], each heterogeneous agent that is to collide rotates by an angle of

$$- \frac{π}{6}$$

to avoid the collision, as shown in Equation (10):

$${V}_{a d o} = [ \begin{matrix}cos ( - \frac{π}{6} ) & - sin ( - \frac{π}{6} ) \\ sin ( - \frac{π}{6} ) & cos ( - \frac{π}{6} )\end{matrix} ] [ \begin{matrix}{x}_{c} \\ {y}_{c}\end{matrix} ] , \qquad ( 10 )$$

where

V_{ado} denotes the avoid-dynamic-obstacle behavior.

In a further technical solution, a specific method for step 3 is as follows:

step 1: establishing an N*5-dimensional matrix P(N, 5), where N is the sum of the number of surface unmanned vehicles and the number of autonomous underwater vehicles;

step 2: initializing a population: randomly generating an initialized population by initializing a population size, a sampling time, the number of iterations, a value range of a parameter, and quantum mutation probabilities αᵢ=1/\sqrt{2} and βᵢ=1/\sqrt{2};

step 3: calculating a value of a fitness function fitfun for each individual and using the value as a target value for the next evolution;

step 4: recording and storing an optimal strategy result to determine a range of a next-generation population;

step 5: determining an iteration condition: determining whether a formation task of the surface unmanned vehicle and the autonomous underwater vehicle is completed; and if a termination condition is met, outputting a parameter matrix of the optimal result P(N, 5), outputting an optimal control strategy, and ending the process; or otherwise, continuing with the next step;

step 6: performing a crossover operation on previous-generation individuals by using a cloud crossover operator p_{c};

step 7: performing a mutation operation on the individuals by using a cloud mutation operator pₘ to generate the new-generation population;

step 8: updating a quantum gate by using a quantum rotation gate; and

step 9: updating the number (t=t+1) of iterations, and returning to step 3.

In a further technical solution, the value of the fitness function fitfun is as follows:

fitfun=γ₁S_{formation}+γ₂D_{follower}+γ₃C_{U/A}+γ₄C_{obstacle}+γ₅S_{leader}, where

where S_{formation} denotes the sum of paths of the heterogeneous agents in a formation during task execution; D_{follower} denotes a formation deviation value of a heterogeneous agent in the formation; C_{U/A} denotes the number of collisions between the heterogeneous agents in the formation; C_{obstacle} denotes the number of collisions between an obstacle in an environment and the heterogeneous agents; S_{leader} denotes the number of moving steps of the leader heterogeneous agent in the formation; and γ₁, γ₂, γ₃, γ₄, γ₅ are respectively weights of S_{formation}, D_{follower}, C_{U/A}, C_{obstacle}, and S_{leader}.

According to the foregoing technical solutions, the heterogeneous agent formation control method based on a cloud-model-based quantum genetic algorithm provided in the present invention has the following beneficial effects:

In the present invention, respective operating characteristics of a USV and an AUV are combined to form integrated water surface-to-underwater formation control to improve operating efficiency and expand an operating range. Based on respective advantages and disadvantages of a leader-follower method and a behavior-based method, the two methods are combined to classify formation behaviors into two levels: a behavior decision-making level and an action execution level. The behavior decision-making level is classified from a perspective of overall behaviors of a formation, including: a move-to-goal behavior, a keep-formation behavior, an avoid-static-obstacle behavior, and an avoid-dynamic-obstacle behavior. The action execution level is classified from a perspective of individual behaviors of agents which are classified into two roles: a leader and a follower. In the present invention, a cloud-model-based quantum genetic algorithm is used to optimize weight coefficients of various behaviors. This algorithm generates a cloud crossover operator and a cloud mutation operator by using cloud droplets in a cloud model. The cloud droplets feature randomness and bias stability, thereby overcoming defects of prematurity and a low search speed, and improving convergence performance and robustness of the algorithm.

### BRIEF DESCRIPTION OF DRAWINGS

To describe the technical solutions in the embodiments of the present invention or in the prior art more clearly, the following briefly describes the accompanying drawings required for describing the embodiments or the prior art.

FIG. 1 is a schematic diagram illustrating a heterogeneous agent network constructed in the present invention;

FIG. 2 is a schematic diagram illustrating established coordinate systems;

FIG. 3 shows a locational relationship between an agent to a static obstacle;

FIG. 4 is a block diagram illustrating behavior-based heterogeneous agent formation control; and

FIG. 5 is a flowchart of a cloud model-based quantum genetic algorithm.

### DESCRIPTION OF EMBODIMENTS

The technical solutions in the embodiments of the present application are clearly and completely described below with reference to the accompanying drawings in the embodiments of the present application.

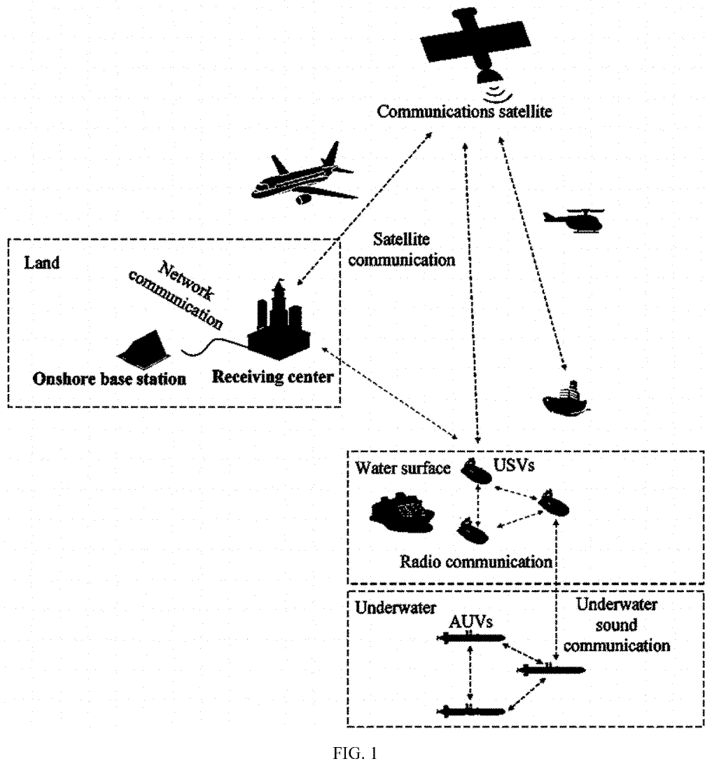

The present invention provides a heterogeneous agent formation control method based on a cloud-model-based quantum genetic algorithm. In the present invention, a heterogeneous agent network shown in FIG. 1 is constructed by combining respective operating characteristics of an unmanned surface vehicle (USV) and an autonomous underwater vehicle (AUV) for formation control, so as to implement observation in a wide range at high efficiency. The specific control method includes the following steps.

Step 1: Establish a dynamics model of a surface unmanned vehicle and an autonomous underwater vehicle.

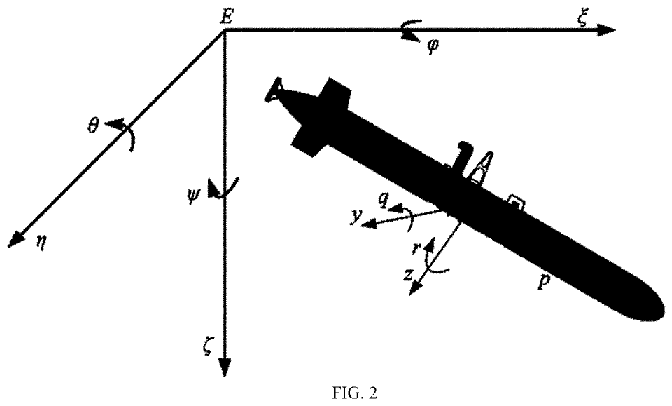

First, coordinate systems are established, including a fixed coordinate system and a motion coordinate system, as shown in FIG. 2. An origin E of the fixed coordinate system (E−ξηζ) is fixed to the Earth, and may optionally be a certain point on the sea surface or in the sea. An origin O of the motion coordinate system (O−xyz) is fixed to a USV or an AUV; Main parameters are listed in Table 1.

TABLE 1
Motion parameters and symbols

| Vector | x axis | y axis | z axis |
|---|---|---|---|
| Linear velocity | (roll angle) | (pitch angle) | (heading angle) |
| Angular velocity | | | |
| Euler angle | | | |
| Displacement | | | |

A three-degrees of freedom dynamics model is established without considering a motion in the z direction for the surface unmanned vehicle, as shown in Equation (1):

$$\{ \begin{matrix}{\dot{ξ}}^{U} = {u}^{U} cos {ψ}^{U} - {v}^{U} sin {ψ}^{U} \\ {\dot{η}}^{U} = {u}^{U} sin {ψ}^{U} + {v}^{U} cos {ψ}^{U} \\ {\dot{ψ}}^{U} = {r}^{U}\end{matrix} , \qquad ( 1 )$$

where

\dot{ξ}^{U} denotes a derivative of displacement of the surface unmanned vehicle along an x axis; u^{U} denotes a linear velocity of the surface unmanned vehicle along the x axis; ψ^{U} denotes a heading angle of the surface unmanned vehicle; v^{U} denotes a linear velocity of the surface unmanned vehicle along a y axis; \dot{η}^{U} denotes a derivative of displacement of the surface unmanned vehicle along the y axis; \dot{ψ}^{U} denotes a derivative of the heading angle of the surface unmanned vehicle; and r^{U} denotes a yaw angular velocity of the surface unmanned vehicle.

A six-degrees of freedom dynamics model is established for the autonomous underwater vehicle, as shown in Equation (2):

$$\{ \begin{matrix}{\dot{ξ}}^{A} = \begin{matrix}{u}^{A} cos {θ}^{A} cos {ψ}^{A} + {v}^{A} ( sin {φ}^{A} sin {θ}^{A} cos {ψ}^{A} - cos {ψ}^{A} sin {ψ}^{A} ) + \\ {w}^{A} ( sin {φ}^{A} sin {ψ}^{A} - cos {φ}^{A} sin {θ}^{A} cos {ψ}^{A} )\end{matrix} \\ {\dot{η}}^{A} = \begin{matrix}{u}^{A} cos {θ}^{A} sin {ψ}^{A} + {v}^{A} ( cos {φ}^{A} cos {ψ}^{A} - sin {φ}^{A} sin {θ}^{A} sin {ψ}^{A} ) + \\ {w}^{A} ( cos {φ}^{A} sin {θ}^{A} sin {ψ}^{A} - sin {φ}^{A} cos {ψ}^{A} )\end{matrix} \\ {\dot{ζ}}^{A} = - {u}^{A} sin {θ}^{A} + {ν}^{4} cos {θ}^{A} sin {φ}^{A} + {w}^{A} cos {θ}^{A} cos {φ}^{A} \\ {\dot{φ}}^{A} = {p}^{A} + {\dot{ψ}}^{A} sin {θ}^{A} \\ {\dot{θ}}^{A} = {q}^{A} cos {φ}^{A} - {r}^{A} sin {φ}^{A} \\ {\dot{ψ}}^{A} = \frac{{r}^{A} cos {φ}^{A} - {q}^{A} sin {φ}^{A}}{cos {θ}^{A}}\end{matrix} , \qquad ( 2 )$$

where

\dot{ξ}^{A} denotes a derivative of displacement of the autonomous underwater vehicle along the x axis; u^{A} denotes a linear velocity of the autonomous under water vehicle along the x axis; θ^{A} denotes a pitch angle of the autonomous underwater vehicle; ψ^{A} denotes a heading angle of the autonomous underwater vehicle; v^{A} denotes a linear velocity of the autonomous underwater vehicle along they axis; φ^{A} denotes a roll angle of the autonomous underwater vehicle; w^{A} denotes a linear velocity of the autonomous underwater vehicle along the z axis; \dot{η}^{A} denotes a derivative of displacement of the autonomous underwater vehicle along the y axis; \dot{ζ}^{A} denotes a derivative of displacement of the autonomous underwater vehicle along the z axis; \dot{φ}^{A} denotes a derivative of the roll angle of the autonomous underwater vehicle; p^{A} denotes a heeling angular velocity of the autonomous underwater vehicle; \dot{ψ}^{A} denotes a derivative of the heading angle of the autonomous underwater vehicle; \dot{θ}^{A} denotes a derivative of the pitch angle of the autonomous underwater vehicle; q^{A} denotes a trim angular velocity of the autonomous underwater vehicle; and r^{A} denotes a yaw angular velocity of the autonomous underwater vehicle.

Step 2: Design formation behaviors of the heterogeneous agents based on a behavior algorithm and a leader-follower algorithm by using the established dynamics model of a surface unmanned vehicle and an autonomous underwater vehicle.

The formation behaviors of the agents are classified based on the idea of a behavior-based formation control strategy. As shown in Table 2, the formation behaviors are classified into two levels: a behavior decision-making level and an action execution level. The behavior decision-making level is classified from a perspective of overall behaviors of a formation, including: a move-to-goal behavior, a keep-formation behavior, an avoid-static-obstacle behavior, and an avoid-dynamic-obstacle behavior.

The action execution level is classified from a perspective of individual behaviors of agents which are classified into two roles: a leader and a follower. Each follower keeps the formation by maintaining a certain distance and angle from the leader. Different network topologies may be formed based on different distances and angles, such as a straight-line topology, a triangle topology, a diamond topology, a regular polygon topology, and a tree topology. The follower continuously rectifies a location deviation to ensure successful completion of an agent formation task. Behaviors of the leader include the move-to-goal behavior, the avoid-static-obstacle behavior, and the avoid-dynamic-obstacle behavior, and behaviors of the follower include the keep-formation behavior, the avoid-static-obstacle behavior, and the avoid-dynamic-obstacle behavior.

TABLE 2
Classification of the behavior decision-making level and the
action execution level

| Behavior | Action execution level | |
|---|---|---|
| decision-making level | Leader | Follower |
| Move-to-goal | Strategy for | Follow-up strategy |
| behavior | reaching the goal | |
| Keep-formation | Moving along a | Tracking the leader at a |
| behavior | planned path | certain distance and angle |
| Avoid-static-obstacle | Avoiding a static | Replicating a route of the |
| behavior | obstacle | leader |
| Avoid-dynamic-obsta | Avoiding another | Avoiding another agent |
| de behavior | agent | |

1. Move-to-Goal Behavior

A current location and a goal location of the surface unmanned vehicle are respectively (x_{c}^{U}, y_{c}^{U}) and (x_{g}^{U}, y_{g}^{U}), and an output vector of the move-to-goal behavior of the surface unmanned vehicle is shown in Equation (3):

$${V}_{m t g}^{U} = \frac{1}{\sqrt{{( {x}_{g}^{U} - {x}_{c}^{U} )}^{2} + {( {y}_{g}^{U} - {y}_{c}^{U} )}^{2}}} ( \begin{matrix}{x}_{g}^{U} - {x}_{c}^{U} \\ {y}_{g}^{U} - {y}_{c}^{U}\end{matrix} ) ; \qquad ( 3 )$$

and

a current location and a goal location of the autonomous underwater vehicle are respectively (x_{c}^{A}, y_{c}^{A}, z_{c}^{A}) and (x_{g}^{A}, y_{g}^{A}, z_{g}^{A}), and an output vector of the move-to-goal behavior of the autonomous underwater vehicle is shown in Equation (4):

$${V}_{m t g}^{A} = \frac{1}{\sqrt{{( {x}_{g}^{A} - {x}_{c}^{A} )}^{2} + {( {y}_{g}^{A} - {y}_{c}^{A} )}^{2} + {( {z}_{g}^{A} - {z}_{c}^{A} )}^{2}}} ( \begin{matrix}{x}_{g}^{A} - {x}_{c}^{A} \\ {y}_{g}^{A} - {y}_{c}^{A} \\ {z}_{g}^{A} - {z}_{c}^{A}\end{matrix} ) . \qquad ( 4 )$$

The leader considers only the move-to-goal behavior without considering the keep-formation behavior.

2. Keep-Formation Behavior

The keep-formation behavior refers to that after a formation is formed, the agents determine a goal location in the formation to generate an output vector of the expected location. When a current location of an agent is different from the expected location, the agent advances towards an ideal formation location. This behavior is considered only by the follower but not by the leader.

A goal location of the keep-formation behavior of the surface unmanned vehicle is (x_{fg}^{U}, y_{fg}^{U}), and an output vector of the keep-formation behavior of the surface unmanned vehicle is shown in Equation (5):

$${V}_{k f}^{U} = \frac{1}{\sqrt{{( {x}_{f g}^{U} - {x}_{c}^{U} )}^{2} + {( {y}_{f g}^{U} - {y}_{c}^{U} )}^{2}}} ( \begin{matrix}{x}_{fg}^{U} - {x}_{c}^{U} \\ {y}_{f g}^{U} - {y}_{c}^{U}\end{matrix} ) ; \qquad ( 5 )$$

and

a goal location of the keep-formation behavior of the autonomous underwater vehicle is (x_{fg}^{A}, y_{fg}^{A}, z_{fg}^{A}), and an output vector of the keep-formation behavior of the autonomous underwater vehicle is shown in Equation (6):

$${V}_{k f}^{A} = \frac{1}{\sqrt{{( {x}_{f g}^{A} - {x}_{c}^{A} )}^{2} + {( {y}_{fg}^{A} - {y}_{c}^{A} )}^{2} + {( {z}_{f g}^{A} - {z}_{c}^{A} )}^{2}}} ( \begin{matrix}{x}_{fg}^{A} - {x}_{c}^{A} \\ {y}_{f g}^{A} - {y}_{c}^{A} \\ {z}_{fg}^{A} - {z}_{c}^{A}\end{matrix} ) . \qquad ( 6 )$$

3. Avoid-Static-Obstacle Behavior

During task execution, avoidance of collisions with static obstacles needs to be fully considered for an agent formation. This behavior needs to be considered by both types of agents. The follower replicates a route of the leader. When detecting that an obstacle hinders its advancement, a heterogeneous agents makes a decision by using an obstacle avoidance function, and the obstacle avoidance function is defined as follows:

$${f}_{{OR}_{i}} = max \{ 0 , {N}_{O {R}_{i}} ( k ) \} ; \\ where \qquad ( 7 )$$

$${N}_{O {R}_{i}} = \{ \begin{matrix}\begin{matrix}1 / d ( {P}_{{R}_{i}} ( k ) , {P}_{O {R}_{i}} ( k - 1 ) ) , \\ R < d ( {P}_{{R}_{i}} ( k ) , {P}_{O {R}_{i}} ( k - 1 ) ) < R + D\end{matrix} \\ 0 , d ( {P}_{{R}_{i}} ( k ) , {P}_{O {R}_{i}} ( k - 1 ) ) \geq R + D\end{matrix} ; \qquad ( 8 )$$

where

P_{R}_{ᵢ}(k) is an expected location in the k^{th} step; P_{OR}_{ᵢ}(k−1) is an edge location of an obstacle detected in the (k−1)^{th} step; D is a danger area range of the obstacle; R denotes an operating radius of the heterogeneous agent; d denotes a distance between the k^{th} step and the (k−1)^{th} step; when f_{OR}_{ᵢ}=0, the obstacle does not need to be avoided; when f_{OR}_{ᵢ}≠0, the obstacle needs to be avoided; and in an obstacle avoidance process, no positive direction but only an xoy plane needs to be considered for the surface unmanned vehicle.

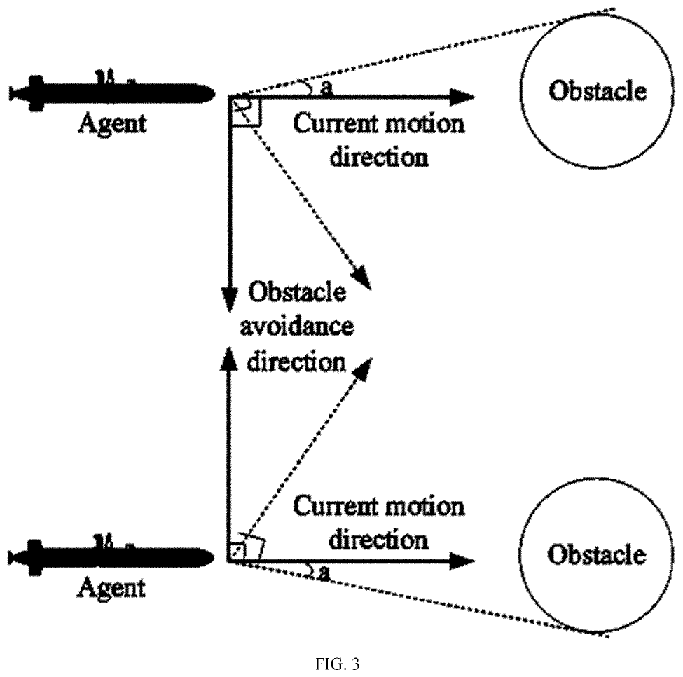

Assuming that a current location of the heterogeneous agent is [x_{c}, y_{c}], a locational relationship between the agent and a static obstacle is shown in FIG. 3. Assuming that an included angle between a tangent line (between the heterogeneous agent and a boundary of the obstacle) and a current navigation direction is α, if

$$α < \frac{π}{4} ,$$

the heterogeneous agent rotates by an angle of δ; or if

$$α \geq \frac{π}{4} ,$$

the agent rotates by angle of

$$\frac{π}{2} .$$

The avoid-static-obstacle behavior of the heterogeneous agent is shown in Equation (9), where rotation to the left is positive and rotation to the right is negative:

$${V}_{aso} = [ \begin{matrix}cos ( \pm δ ) & - sin ( \pm δ ) \\ sin ( \pm δ ) & cos ( \pm δ )\end{matrix} ] [ \begin{matrix}{x}_{c} \\ {y}_{c}\end{matrix} ] , \qquad ( 9 )$$

where

Vₐₛₒ denotes the avoid-static-obstacle behavior of the heterogeneous agent, and δ denotes a rotation angle of the heterogeneous agent.

4. Avoid-Dynamic-Obstacle Behavior

In addition to avoiding a static obstacle in an environment, an agent needs to prevent a collision with another agent in the formation, so that a formation control process can be carried out smoothly. When an agent determines, based on the collision avoidance function, that it is likely to collide with a neighbor agent in its own motion direction, the neighbor agent may simultaneously detect state information of the agent with which the neighbor agent is likely to collide. This behavior needs to be considered by both the leader and the follower. Assuming that a current location of a heterogeneous agent is [x_{c}, y_{c}], each heterogeneous agent that is to collide rotates by an angle of

$$- \frac{π}{6}$$

to avoid the collision, as shown in Equation (10):

$${V}_{a d o} = [ \begin{matrix}cos ( - \frac{π}{6} ) & - sin ( - \frac{π}{6} ) \\ sin ( - \frac{π}{6} ) & cos ( - \frac{π}{6} )\end{matrix} ] [ \begin{matrix}{x}_{c} \\ {y}_{c}\end{matrix} ] , \qquad ( 10 )$$

where

V_{ado} denotes the avoid-dynamic-obstacle behavior.

Step 3: Optimize weight coefficients of different behaviors of the heterogeneous agents based on a cloud-model-based quantum genetic algorithm by using the established dynamics model of a surface unmanned vehicle and an autonomous underwater vehicle to obtain an optimal formation control strategy and implement formation control over the heterogeneous agents.

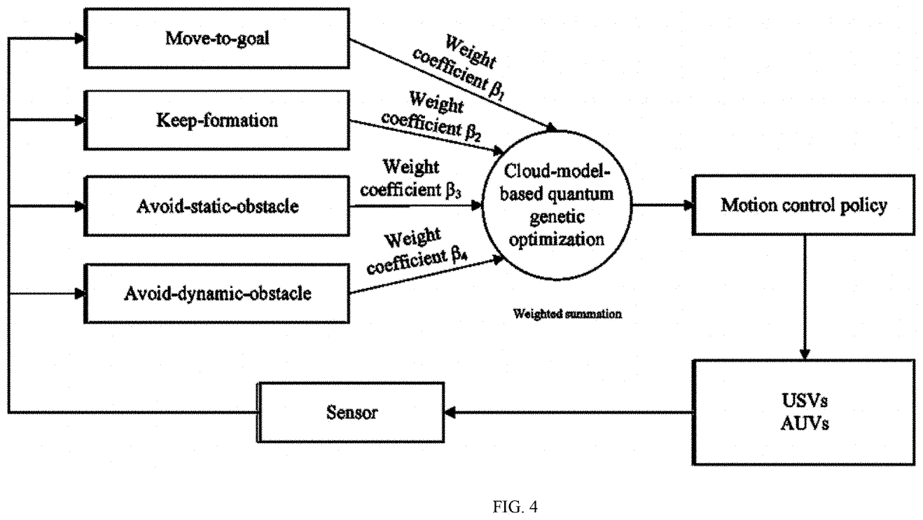

In behavior-based heterogeneous multi-agent formation control, different weight coefficients are selected for different environments and tasks. In most cases, the weight coefficients are selected depending on the designer's experience, but it is very difficult to find a suitable set of coefficients when there are many agents in the system. Therefore, the behavior weight coefficients are selected by using an optimization algorithm. As such, more suitable behavior weight coefficients can be effectively obtained to output an optimal control strategy and improve formation control performance. The cloud-model-based quantum genetic algorithm is a highly effective optimization and solving method. In the present invention, this algorithm is used to optimize the behavior-based weight coefficients, so that formation control can be more effectively implemented between the heterogeneous agents. In the present invention, a vector synthesis method based on the Motor Schema structure is used to output a behavior obtained by weighting and summing up multiple basic behaviors, and a structure thereof is shown in FIG. 4.

Weights of the move-to-goal behavior the avoid-static-obstacle behavior, and the avoid-dynamic-obstacle behavior of the leader agent are optimized. Weights of the keep-formation behavior, the avoid-static-obstacle behavior, and the avoid-dynamic-obstacle behavior of the follower agent are optimized.

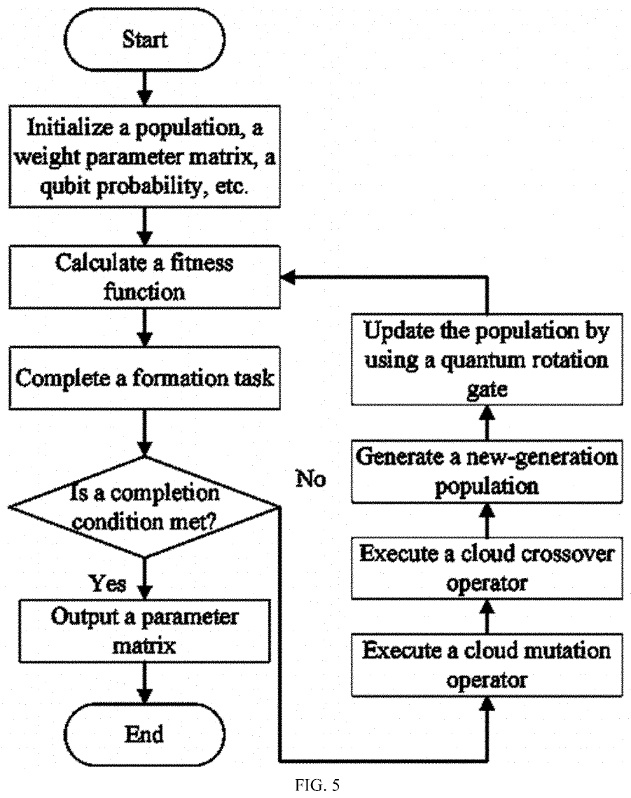

As shown in FIG. 5, a specific method process is as follows:

Step 1: Establish an N*5-dimensional matrix P(N, 5), where N is the sum of the number of surface unmanned vehicles and the number of autonomous underwater vehicles. In this embodiment, N=6, and there are 3 surface unmanned vehicles and 3 autonomous underwater vehicles.

Step 2: Initialize a population: randomly generate an initialized population by initializing a population size, a sampling time, the number of iterations, a value range of a parameter, and quantum mutation probabilities αᵢ=1/\sqrt{2} and βᵢ=1/\sqrt{2}.

Step 3: Calculate a value of a fitness function fitfun for each individual and using the value as a target value for the next evolution.

The value of the fitness function fitfun is as follows:

fitfun=γ₁S_{formation}+γ₂D_{follower}+γ₃C_{U/A}+γ₄C_{obstacle}+γ₅S_{leader}, where

S_{formation} denotes the sum of paths of the heterogeneous agents in a formation during task execution; D_{follower} denotes a formation deviation value of a heterogeneous agent in the formation; C_{U/A} denotes the number of collisions between the heterogeneous agents in the formation; C_{obstacle} denotes the number of collisions between an obstacle in an environment and the heterogeneous agents; S_{leader} denotes the number of moving steps of the leader heterogeneous agent in the formation; and γ₁, γ₂, γ₃, γ₄, γ₅ are respectively weights of S_{formation}, D_{follower}, C_{U/A}, C_{obstacle}, and S_{leader}. In this embodiment, γ₁=1, γ₂=2, γ₃=γ₄=10, and γ₅=5.

Step 4: Record and store an optimal strategy result to determine a range of a next-generation population.

Step 5: Determine an iteration condition: determine whether a formation task of the surface unmanned vehicle and the autonomous underwater vehicle is completed; and if a termination condition is met, output a parameter matrix of the optimal result P(N, 5), output an optimal control strategy, and end the process; or otherwise, continue with the next step.

Step 6: Perform a crossover operation on previous-generation individuals by using a cloud crossover operator p_{c}:

$${p}_{c} = \{ \begin{matrix}{t}_{1} {e}^{- {( {x}_{i}^{′} - {E}_{x} )}^{2} / 2 {E}_{n}^{′2}} , f \geq \overline{F} \\ {t}_{2} , f < \overline{F}\end{matrix} , \qquad ( 11 )$$

where

F̅ denotes a mean fitness value of a population; f is an individual with a larger fitness value in two individuals selected to be crossed over; t₁, t₂ is a constant; and e^{-(x′}^{ᵢ}^{-E}^{ₓ}⁾^{²}^{/2E′}^{ₙ}^{²} denotes a normal distribution of a membership cloud.

Step 7: Perform a mutation operation on the individuals by using a cloud mutation operator pₘ to generate the new-generation population:

$${p}_{m} = \{ \begin{matrix}{s}_{1} {e}^{- {( {x}_{i}^{′} - {E}_{x} )}^{2} / 2 {E}_{n}^{′2}} , f \geq \overline{F} \\ {s}_{2} , f < \overline{F}\end{matrix} , \qquad ( 12 )$$

where

s₁, s₂ is a constant.

Step 8: Update a quantum gate by using a quantum rotation gate.

An update process using the quantum rotation gate is shown in Equations (13) and (14):

$$\begin{matrix}U ( {ϑ}_{i} ) = [ \begin{matrix}cos ( {ϑ}_{i} ) & - s in ( {ϑ}_{i} ) \\ s in ( {ϑ}_{i} ) & cos ( {ϑ}_{i} )\end{matrix} ] ; and & ( 13 ) \\ \vert \begin{matrix}{α}_{i}^{′} \\ {β}_{i}^{′}\end{matrix} \vert = U ( {ϑ}_{i} ) \vert \begin{matrix}{α}_{i} \\ {β}_{i}\end{matrix} \vert = [ \begin{matrix}cos ( {ϑ}_{i} ) & - s in ( {ϑ}_{i} ) \\ s in ( {ϑ}_{i} ) & cos ( {ϑ}_{i} )\end{matrix} ] \vert \begin{matrix}{α}_{i} \\ {β}_{i}\end{matrix} \vert , where & ( 14 ) \\ \vert \begin{matrix}{α}_{i} \\ {β}_{i}\end{matrix} \vert & \end{matrix}$$

denotes a probabilistic amplitude of the i^{th} qubit;

$$\vert \begin{matrix}{α}_{i}^{′} \\ {β}_{i}^{′}\end{matrix} \vert$$

denotes an updated probabilistic amplitude of the i^{th} qubit; ϑᵢ and is a rotation angle. A size and a direction of the rotation angle are determined according to Table 3.

TABLE 3
Quantum rotation gate-based update strategy table

| | | [symbol] i | | | | | |
|---|---|---|---|---|---|---|---|
| [symbol] i | [symbol] i | [symbol] i | [symbol] i | | | | |
| 0 | 0 | F | 0 | 0 | 0 | 0 | 0 |
| 0 | 0 | T | 0 | 0 | 0 | 0 | 0 |
| 0 | 1 | F | | 1 | −1 | 0 | |
| 0 | 1 | T | | −1 | 1 | | 0 |
| 1 | 0 | F | | −1 | 1 | | 0 |
| 1 | 0 | T | | 1 | −1 | 0 | |
| 1 | 1 | F | 0 | 0 | 0 | 0 | 0 |
| 1 | 1 | T | 0 | 0 | 0 | 0 | 0 |

[symbol]

indicates data missing or illegible when filed

Step 9: Update the number (t=t+1) of iterations, and return to step 3.

The embodiments disclosed above are described to enable a person skilled in the art to implement or use the present invention. Various modifications to the embodiments are obvious to the person skilled in the art, and general principles defined in this specification may be implemented in other embodiments without departing from the spirit or scope of the present invention. Therefore, the present invention will not be limited to the embodiments described in this specification but extends to the widest scope that complies with the principles and novelty disclosed in this specification.

What is claimed is:

1. A heterogeneous agent formation control method based on a cloud-model-based quantum genetic algorithm, wherein heterogeneous agents comprise a surface unmanned vehicle and an autonomous underwater vehicle, and the control method comprises the following steps:
step 1: establishing a dynamics model of a surface unmanned vehicle and an autonomous underwater vehicle;
step 2: designing formation behaviors of the heterogeneous agents based on a behavior algorithm and a leader-follower algorithm by using the established dynamics model of a surface unmanned vehicle and an autonomous underwater vehicle; and
step 3: optimizing weight coefficients of different behaviors of the heterogeneous agents based on a cloud-model-based quantum genetic algorithm by using the established dynamics model of a surface unmanned vehicle and an autonomous underwater vehicle to obtain an optimal formation control strategy and implement formation control over the heterogeneous agents.

2. The heterogeneous agent formation control method based on a cloud-model-based quantum genetic algorithm according to claim 1, wherein in step 1, a three-degrees of freedom dynamics model is established without considering a motion in a z direction for the surface unmanned vehicle, as shown in Equation (1):
$$\{ \begin{matrix}{\dot{ξ}}^{U} = {u}^{U} cos {ψ}^{U} - {v}^{U} sin {ψ}^{U} \\ {\dot{η}}^{U} = {u}^{U} sin {ψ}^{U} + {v}^{U} cos {ψ}^{U} \\ {\dot{ψ}}^{U} = {r}^{U}\end{matrix} , \qquad ( 1 )$$
wherein
\dot{ξ}^{U} denotes a derivative of displacement of the surface unmanned vehicle along an x axis; u^{U} denotes a linear velocity of the surface unmanned vehicle along the x axis; ψ^{U} denotes a heading angle of the surface unmanned vehicle; v^{U} denotes a linear velocity of the surface unmanned vehicle along a y axis; \dot{η}^{U} denotes a derivative of displacement of the surface unmanned vehicle along the y axis; \dot{ψ}^{U} denotes a derivative of the heading angle of the surface unmanned vehicle; and r^{U} denotes a yaw angular velocity of the surface unmanned vehicle; and
a six-degrees of freedom dynamics model is established for the autonomous underwater vehicle, as shown in Equation (2):
$$\{ \begin{matrix}{\dot{ξ}}^{A} = {u}^{A} cos {θ}^{A} cos {ψ}^{A} + {v}^{A} ( sin {φ}^{A} sin {θ}^{A} cos {ψ}^{A} - cos {ψ}^{A} sin {ψ}^{A} ) + {w}^{A} ( sin {φ}^{A} sin {ψ}^{A} - cos {φ}^{A} sin {θ}^{A} cos {ψ}^{A} ) \\ {\dot{η}}^{A} = {u}^{A} cos {θ}^{A} sin {ψ}^{A} + {v}^{A} ( cos {φ}^{A} cos {ψ}^{A} - sin {φ}^{A} sin {θ}^{A} sin {ψ}^{A} ) + {w}^{A} ( cos {φ}^{A} sin {θ}^{A} sin {ψ}^{A} - sin {φ}^{A} cos {ψ}^{A} ) \\ {\dot{ζ}}^{A} = - {u}^{A} sin {θ}^{A} + {v}^{A} cos {θ}^{A} sin {φ}^{A} + {w}^{A} cos {θ}^{A} cos {φ}^{A} \\ {\dot{φ}}^{A} = {p}^{A} + {\dot{ψ}}^{A} sin {θ}^{A} \\ {\dot{θ}}^{A} = {q}^{A} cos {φ}^{A} - {r}^{A} sin {φ}^{A} \\ {\dot{ψ}}^{A} = \frac{{r}^{A} cos {φ}^{A} - {q}^{A} sin {φ}^{A}}{cos {θ}^{A}}\end{matrix} , \qquad ( 2 )$$
wherein
\dot{ξ}^{A} denotes a derivative of displacement of the autonomous underwater vehicle along the x axis; u^{A} denotes a linear velocity of the autonomous underwater vehicle along the x axis; θ^{A} denotes a pitch angle of the autonomous underwater vehicle; ψ^{A} denotes a heading angle of the autonomous underwater vehicle; v^{A} denotes a linear velocity of the autonomous underwater vehicle along the y axis; φ^{A} denotes a roll angle of the autonomous underwater vehicle; w^{A} denotes a linear velocity of the autonomous underwater vehicle along the z axis; \dot{η}^{A} denotes a derivative of displacement of the autonomous underwater vehicle along the y axis; \dot{ζ}^{A} denotes a derivative of displacement of the autonomous underwater vehicle along the z axis; \dot{φ}^{A} denotes a derivative of the roll angle of the autonomous underwater vehicle; p^{A} denotes a heeling angular velocity of the autonomous underwater vehicle; \dot{ψ}^{A} denotes a derivative of the heading angle of the autonomous underwater vehicle; \dot{θ}^{A} denotes a derivative of the pitch angle of the autonomous underwater vehicle; q^{A} denotes a trim angular velocity of the autonomous underwater vehicle; and r^{A} denotes a yaw angular velocity of the autonomous underwater vehicle.

3. The heterogeneous agent formation control method based on a cloud-model-based quantum genetic algorithm according to claim 1, wherein in step 2, the behaviors of the heterogeneous agents are classified into a move-to-goal behavior, a keep-formation behavior, an avoid-static-obstacle behavior, and an avoid-dynamic-obstacle behavior; and the heterogeneous agents comprise a leader and a follower, behaviors of the leader comprise the move-to-goal behavior, the avoid-static-obstacle behavior, and the avoid-dynamic-obstacle behavior, and behaviors of the follower comprise the keep-formation behavior, the avoid-static-obstacle behavior, and the avoid-dynamic-obstacle behavior.

4. The heterogeneous agent formation control method based on a cloud-model-based quantum genetic algorithm according to claim 3, wherein the move-to-goal behavior is as follows: a current location and a goal location of the surface unmanned vehicle are respectively (x_{c}^{U}, y_{c}^{U}) and (x_{g}^{U}, y_{g}^{U}), and an output vector of the move-to-goal behavior of the surface unmanned vehicle is shown in Equation (3):
$${V}_{mtg}^{U} = \frac{1}{\sqrt{{( {x}_{g}^{U} - {x}_{c}^{U} )}^{2} + {( {y}_{g}^{U} - {y}_{c}^{U} )}^{2}}} ( \begin{matrix}{x}_{g}^{U} - {x}_{c}^{U} \\ {y}_{g}^{U} - {y}_{c}^{U}\end{matrix} ) ; \qquad ( 3 )$$
and
a current location and a goal location of the autonomous underwater vehicle are respectively (x_{c}^{A}, y_{c}^{A}, z_{c}^{A}) and (x_{g}^{A}, y_{g}^{A}, z_{g}^{A}), and an output vector of the move-to-goal behavior of the autonomous underwater vehicle is shown in Equation (4):
$${V}_{mtg}^{A} = \frac{1}{\sqrt{{( {x}_{g}^{A} - {x}_{c}^{A} )}^{2} + {( {y}_{g}^{A} - {y}_{c}^{A} )}^{2} + {( {z}_{g}^{A} - {z}_{c}^{A} )}^{2}}} ( \begin{matrix}{x}_{g}^{A} - {x}_{c}^{A} \\ {y}_{g}^{A} - {y}_{c}^{A} \\ {z}_{g}^{A} - {z}_{c}^{A}\end{matrix} ) . \qquad ( 4 )$$

5. The heterogeneous agent formation control method based on a cloud-model-based quantum genetic algorithm according to claim 3, wherein a goal location of the keep-formation behavior of the surface unmanned vehicle is (x_{fg}^{U}, y_{fg}^{U}), and an output vector of the keep-formation behavior of the surface unmanned vehicle is shown in Equation (5):
$${V}_{kf}^{U} = \frac{1}{\sqrt{{( {x}_{fg}^{U} - {x}_{c}^{U} )}^{2} + {( {y}_{fg}^{U} - {y}_{c}^{U} )}^{2}}} ( \begin{matrix}{x}_{fg}^{U} - {x}_{c}^{U} \\ {y}_{fg}^{U} - {y}_{c}^{U}\end{matrix} ) ; \qquad ( 5 )$$
and
a goal location of the keep-formation behavior of the autonomous underwater vehicle is (x_{fg}^{A}, y_{fg}^{A}, z_{fg}^{A}), and an output vector of the keep-formation behavior of the autonomous underwater vehicle is shown in Equation (6):
$${V}_{kf}^{A} = \frac{1}{\sqrt{{( {x}_{fg}^{A} - {x}_{c}^{A} )}^{2} + {( {y}_{fg}^{A} - {y}_{c}^{A} )}^{2} + {( {z}_{fg}^{A} - {z}_{c}^{A} )}^{2}}} ( \begin{matrix}{x}_{fg}^{A} - {x}_{c}^{A} \\ {y}_{fg}^{A} - {y}_{c}^{A} \\ {z}_{fg}^{A} - {z}_{c}^{A}\end{matrix} ) . \qquad ( 6 )$$

6. The heterogeneous agent formation control method based on a cloud-model-based quantum genetic algorithm according to claim 3, wherein the avoid-static-obstacle behavior is as follows: when detecting that an obstacle hinders its advancement, a heterogeneous agent makes a decision by using an obstacle avoidance function, and the obstacle avoidance function is defined as follows:
f_{OR}_{ᵢ}=max{0, N_{OR}_{ᵢ}(k)} (Error! Bookmark not defined.); wherein
$${N}_{O {R}_{i}} = \{ \begin{matrix}1 \text{/} d ( {P}_{{R}_{i}} ( k ) , {P}_{O {R}_{i}} ( k - 1 ) ) , & R < d ( {P}_{{R}_{i}} ( k ) , {P}_{O {R}_{i}} ( k - 1 ) ) < R + D \\ 0 , & d ( {P}_{{R}_{i}} ( k ) , {P}_{{OR}_{i}} ( k - 1 ) ) \geq R + D\end{matrix} ; \qquad ( 7 )$$
wherein
P_{R}_{ᵢ}(k) is an expected location in the k^{th} step; P_{OR}_{ᵢ}(k−1) is an edge location of an obstacle detected in the (k−1)^{th} step; D is a danger area range of the obstacle; R denotes an operating radius of the heterogeneous agent; d denotes a distance between the k^{th} step and the (k−1)^{th} step; when f_{OR}_{ᵢ}=0, the obstacle does not need to be avoided; when f_{OR}_{ᵢ}≠0, the obstacle needs to be avoided; and in an obstacle avoidance process, no positive direction but only an xoy plane needs to be considered for the surface unmanned vehicle;
assuming that a current location of the heterogeneous agent is [x_{c}, y_{c}], and an included angle between a tangent line (between the heterogeneous agent and a boundary of the obstacle) and a current navigation direction is α, if
$$α < \frac{π}{4} ,$$
the heterogeneous agent rotates by an angle of δ; or if
$$α \geq \frac{π}{4} ,$$
the agent rotates by angle of
$$\frac{π}{2} ;$$
and
the avoid-static-obstacle behavior of the heterogeneous agent is shown in Equation (9), wherein rotation to the left is positive and rotation to the right is negative:
$${V}_{a s o} = [ \begin{matrix}cos ( \pm δ ) & - s in ( \pm δ ) \\ sin ( \pm 6 ) & cos ( \pm 6 )\end{matrix} ] [ \begin{matrix}{x}_{c} \\ {y}_{c}\end{matrix} ]$$
(Error! Bookmark not defined.), wherein
Vₐₛₒ denotes the avoid-static-obstacle behavior of the heterogeneous agent, and δ denotes a rotation angle of the heterogeneous agent.

7. The heterogeneous agent formation control method based on a cloud-model-based quantum genetic algorithm according to claim 3, wherein the avoid-dynamic-obstacle behavior is as follows: assuming that a current location of a heterogeneous agent is [x_{c}, y_{c}], each heterogeneous agent that is to collide rotates by an angle of
$$- \frac{π}{6}$$
to avoid the collision, as shown in Equation (10):
$${V}_{a d o} = [ \begin{matrix}cos ( - \frac{π}{6} ) & - sin ( - \frac{π}{6} ) \\ sin ( - \frac{π}{6} ) & cos ( - \frac{π}{6} )\end{matrix} ] [ \begin{matrix}{x}_{c} \\ {y}_{c}\end{matrix} ] ; \qquad ( 8 )$$
wherein
V_{ado} denotes the avoid-dynamic-obstacle behavior.

8. The heterogeneous agent formation control method based on a cloud-model-based quantum genetic algorithm according to claim 3, wherein a specific method for step 3 is as follows:
step 1: establishing an N*5-dimensional matrix P(N, 5), wherein N is the sum of the number of surface unmanned vehicles and the number of autonomous underwater vehicles;
step 2: initializing a population: randomly generating an initialized population by initializing a population size, a sampling time, the number of iterations, a value range of a parameter, and quantum mutation probabilities αᵢ=1/\sqrt{2} and βᵢ=1/\sqrt{2};
step 3: calculating a value of a fitness function fitfun for each individual and using the value as a target value for the next evolution;
step 4: recording and storing an optimal strategy result to determine a range of a next-generation population;
step 5: determining an iteration condition: determining whether a formation task of the surface unmanned vehicle and the autonomous underwater vehicle is completed; and if a termination condition is met, outputting a parameter matrix of the optimal result P(N, 5), outputting an optimal control strategy, and ending the process; or otherwise, continuing with the next step;
step 6: performing a crossover operation on previous-generation individuals by using a cloud crossover operator p_{c};
step 7: performing a mutation operation on the individuals by using a cloud mutation operator pₘ to generate the new-generation population;
step 8: updating a quantum gate by using a quantum rotation gate; and
step 9: updating the number (t=t+1) of iterations, and returning to step 3.

9. The heterogeneous agent formation control method based on a cloud-model-based quantum genetic algorithm according to claim 8, wherein the value of the fitness function fitfun is as follows:
fitfun=γ₁S_{formation}+γ₂D_{follower}+γ₃C_{U/A}+γ₄C_{obstacle}+γ₅S_{leader}, wherein
S_{formation} denotes the sum of paths of the heterogeneous agents in a formation during task execution; D_{follower} denotes a formation deviation value of a heterogeneous agent in the formation; C_{U/A} denotes the number of collisions between the heterogeneous agents in the formation; C_{obstacle} denotes the number of collisions between an obstacle in an environment and the heterogeneous agents; S_{leader} denotes the number of moving steps of the leader heterogeneous agent in the formation; and γ₁, γ₂, γ₃, γ₄, γ₅ are respectively weights of S_{formation}, D_{follower}, C_{U/A}, C_{obstacle}, and S_{leader}.
